(19) United States
(12) Patent Application Publication
(10) Pub. No.: US 2025/0034382 A1
(43) Pub. Date: Jan. 30, 2025

(54) BIODEGRADABLE HEALTHCARE DISPOSABLES AND METHOD OF MAKING

(71) Applicant: BANNACK MEDICAL LLC, Gilbert, AZ (US)

(72) Inventors: Arlen Olsen, Gilbert, AZ (US); Richard Mayer, Chandler, AZ (US); Eric Stuber, Phoenix, AZ (US)

(21) Appl. No.: 18/749,848

(22) Filed: Jun. 21, 2024

Related U.S. Application Data
(60) Provisional application No. 63/528,602, filed on Jul. 24, 2023.
(60) Provisional application No. 63/531,639, filed on Aug. 9, 2023.

(51) Int. Cl. C08L 23/12

(52) U.S. Cl. CPC C08L 23/12; C08L 2201/06; C08L 2203/02; C08L 2203/30; C08L 2205/025; C08L 2205/03

(57) ABSTRACT

Disclosed is a biodegradable disposable wherein: the biodegradable disposable is selected from one of a drape, personal protection equipment, endotracheal tubes (ETTs) and laryngeal mask airways (LMAs), wherein the biodegradable disposable is made of a non-biodegradable polymer selected from a group consisting of polypropylene (PP), polyamide, polyester, polyethylene (PE), polyvinylchloride (PVC) and combinations thereof; and an additive comprising a blend or copolymer of (1) a first polymer selected from a poly-lactic acid (PLA), a polyhydroxyalkanoates (PHA) or a combination thereof and (2) a second polymer which is a poly-terephthalate.

### RELATED REFERENCES

This application claims priority to U.S. provisional patent application Ser. No. 63/528,602 filed Jul. 24, 2023 and U.S. provisional patent application Ser. No. 63/531,639 filed on Aug. 9, 2023, both of which the entirety of is hereby incorporated by reference.

### FIELD OF THE INVENTION

Disclosed is biodegradables disposable. In particular, is a biodegradable disposable, most often, for use in health care facilities to maintain a clean environment, a method and composition.

### BACKGROUND

Disposal of plastic waste is a serious environmental problem. Increased use of plastics has resulted in a growing environmental impact. To combat this, bioplastics such as biodegradable polymers are being developed to be used as an alternative for non-biodegradable polymer materials. The best option for managing non-biodegradable plastic waste is to replace non-biodegradable materials with biodegradable polymers as they are environmentally friendly. Alternatively, non-biodegradable plastics may be recycled. Many of the products that hospitals use are disposable plastic products that are non-biodegradable. This is a problem and a growing concern for hospitals and healthcare facilities meeting sustainability goals.

Recently, hospitals have been replacing many products such as cloth and linens with disposables due to the products retention of infectious disease due to their porosity. Instead, they are moving toward a disposable, such as a nonwoven disposable polypropylene. With increased demand for disposables, this creates a problem for being able to dispose of the disposable after use. Many solutions are being considered other than placing them in landfills, such as recycling. This creates the challenge of having the hospitals obtaining adequate recycling solutions. Many hospitals are also under pressure to come up with sustainability solutions for hospital waste.

### SUMMARY

An aspect is to make a biodegradable disposable or one that will degrade in a landfill much quicker than a conventional plastic such as polypropylene.

Another aspect is to have an additive material that can make most polymeric compositions biodegradable by merely mixing it in with the polymeric material any time before the polymeric material is formed into an article.

One embodiment of the present invention relates a biodegradable disposable wherein: the biodegradable disposable is selected from one of a drape, personal protection equipment, endotracheal tubes (ETTs) and laryngeal mask airways (LMAs), wherein the biodegradable disposable is made of a non-biodegradable polymer selected from a group consisting of polypropylene (PP), polyamide, polyester, polyethylene (PE), polyvinylchloride (PVC) and combinations thereof; and an additive comprising a blend or copolymer of (1) a first polymer selected from a poly-lactic acid (PLA), a polyhydroxyalkanoates (PHA) or a combination thereof and (2) a second polymer which is a poly-terephthalate.

### BRIEF DESCRIPTION

Some of the embodiments will be described in detail, with reference to the following figures, wherein like designations denote like members, wherein:

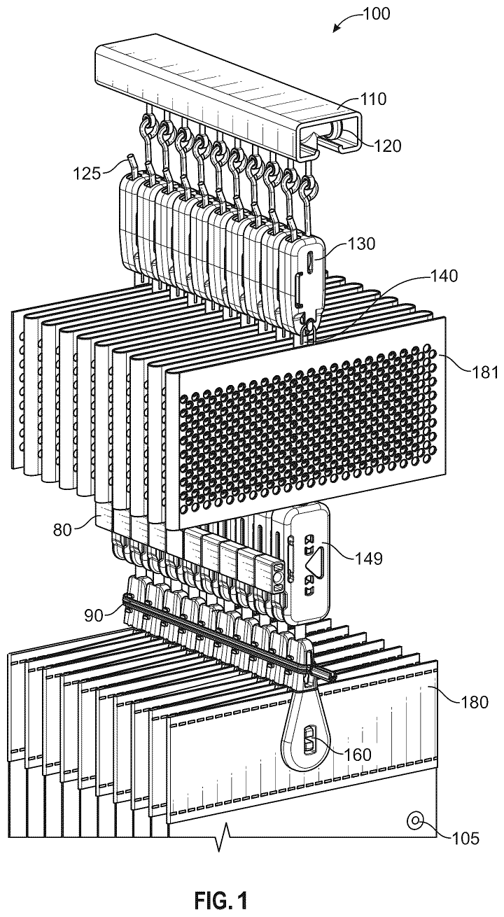

FIG. 1 shows a curtain system according to an embodiment of the invention;

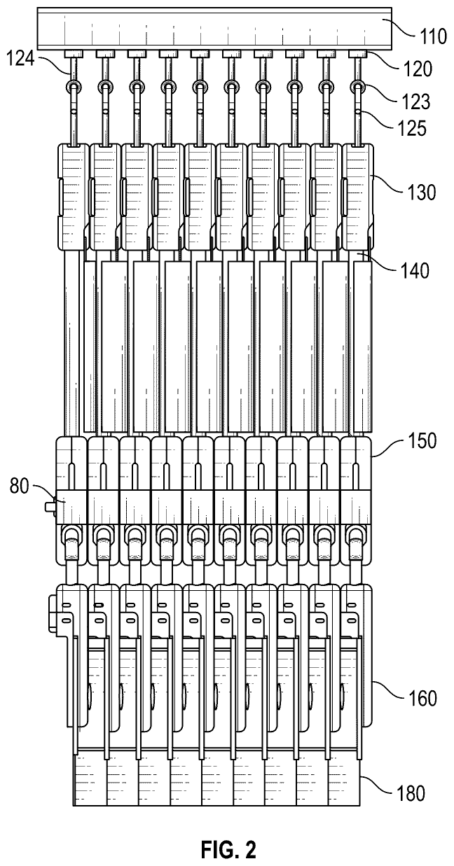

FIG. 2 shows a front view of a curtain system according to an embodiment of the invention;

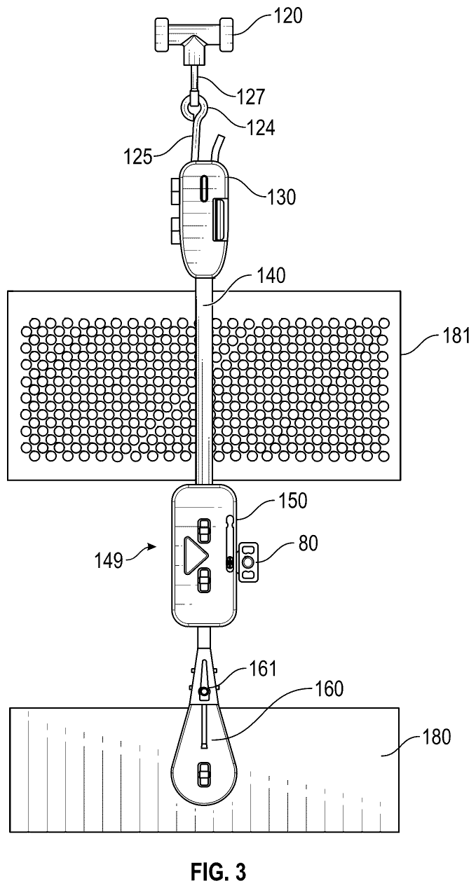

FIG. 3 shows a side view of a curtain system according to an embodiment of the invention;

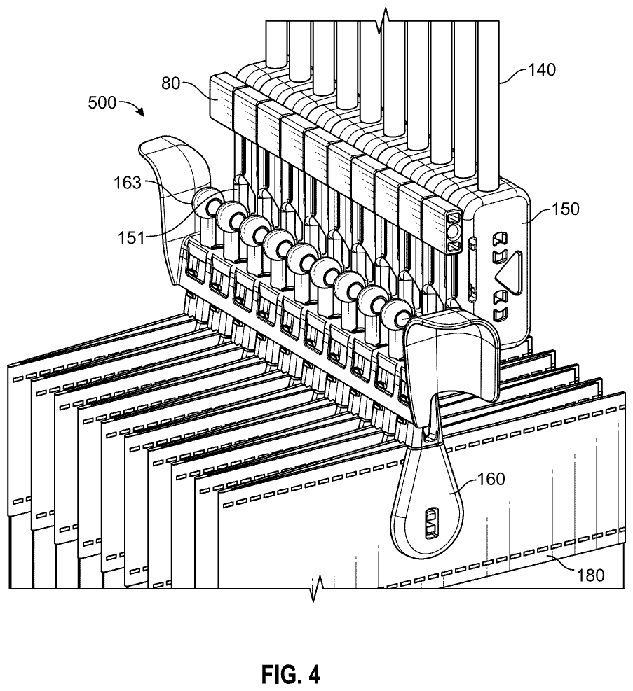

FIG. 4 shows an alternate embodiment of a curtain system of the invention.

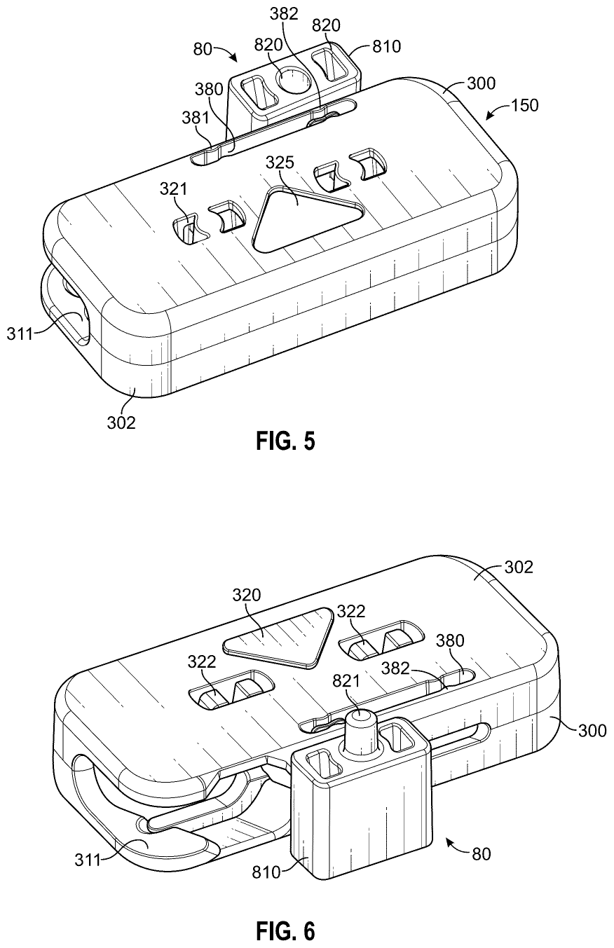

FIG. 5 shows a first perspective view of a quick release system according to an embodiment of the invention;

FIG. 6 shows a second perspective view of a quick release system according to an embodiment of the invention;

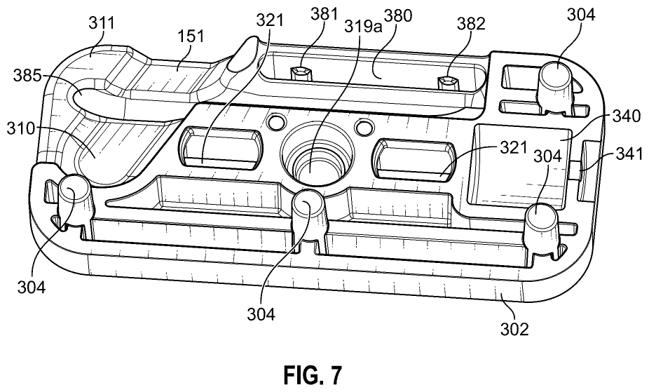

FIG. 7 shows a first side of the inside of a quick release system according to an embodiment of the invention;

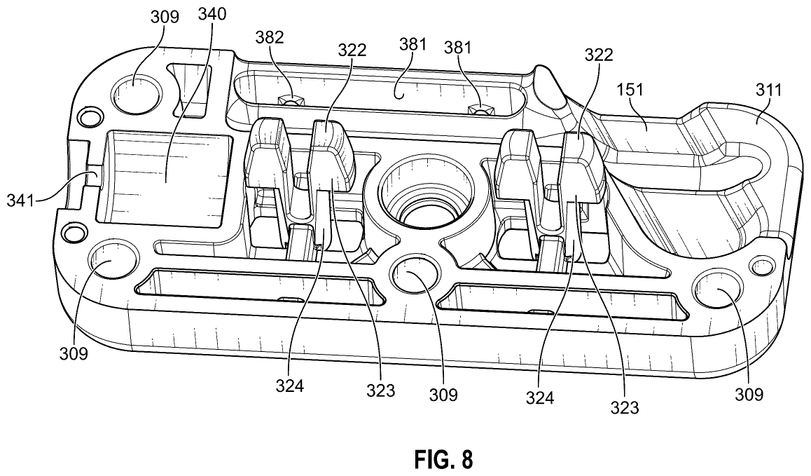

FIG. 8 shows a second side of the inside of a quick release system according to an embodiment of the invention;

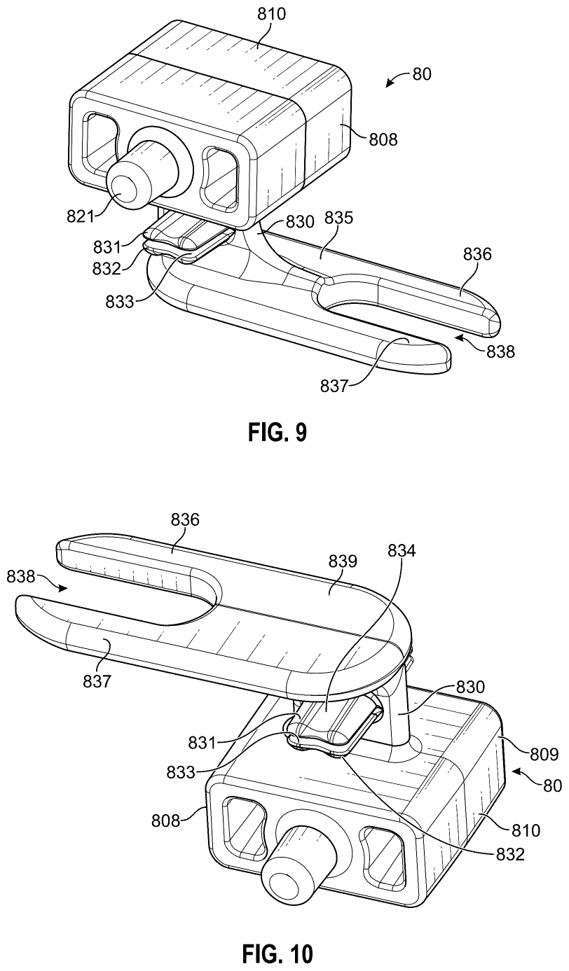

FIG. 9 shows a perspective view of a sliding lock used in a locking mechanism according to an embodiment of the invention;

FIG. 10 shows another perspective view of a sliding lock used in a locking mechanism according to an embodiment of the invention;

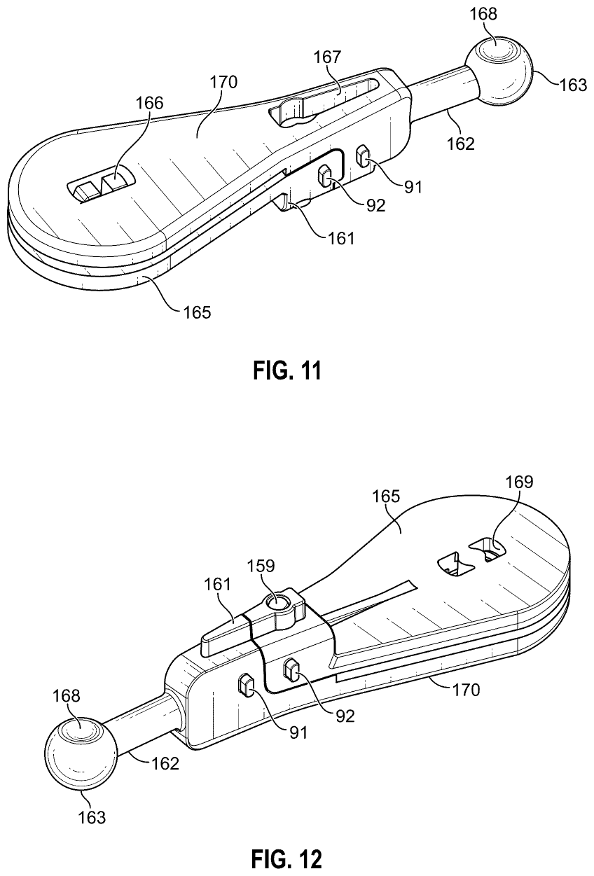

FIG. 11 shows a perspective view of a curtain holder;

FIG. 12 shows another perspective view of a curtain holder;

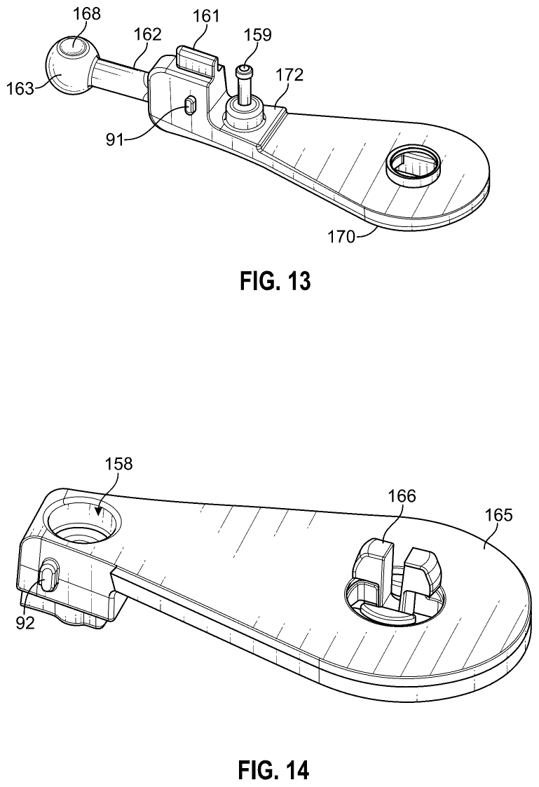

FIG. 13 shows a component of a curtain holder;

FIG. 14 shows another component of a curtain holder;

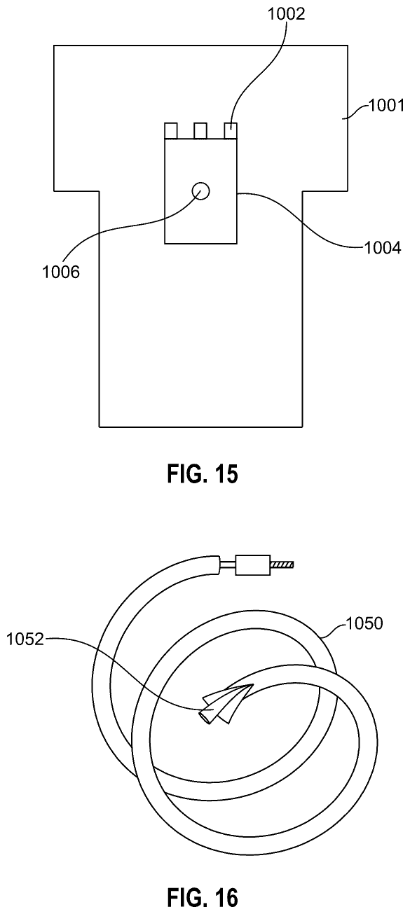

FIG. 15 shows a surgical drape or medical wrap;

FIG. 16. shows a scope sleeve; and

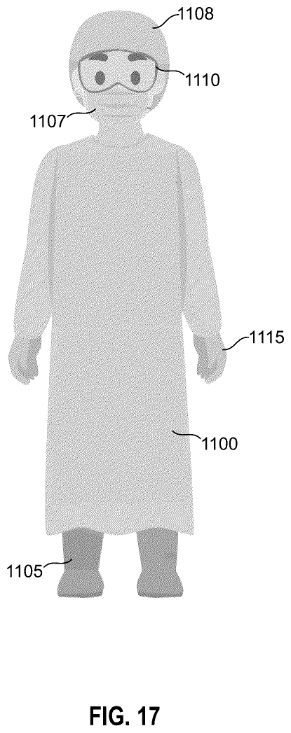

FIG. 17 shows personal protection equipment.

### DETAILED DESCRIPTION

Referring to FIG. 1 is a disposable curtain system 100. The disposable curtain system 100 is attached to the ceiling by a track 110. The track may be attached directly to the ceiling or hang from the ceiling on extensions. Running through the track 110 are roller hooks 120. The roller hooks 120 have a hook 125 on the end thereof for attaching an extension or elongate member 140. So that the extension does not come off the hook 125, a cover 130 for the hook 125 is provided.

The extension 140 may be telescoping poles, poles that may be discreet sizes and interchanged depending on size needed. Since the extension will remain in place it is important that is easily cleanable for infectious diseases with an extension pole that has disinfectant. The material of the extension should not absorb liquids but should be made from a nonabsorbent plastic such as polyvinyl, acrylic, polyacrylic, nylon, carbon composite, PVC, polyethylene or the like. It may also be made from a biodegradable material as hereinafter described.

The curtain 180 comes in discreet sections, such as 6-12 feet and most commonly 9 feet. The curtain discreet sections of 9-12 feet may be snapped together with snaps 105 so as to make longer curtains. The curtains are made from disposable or recyclable, biodegradable material as hereinafter described. The curtains 180 may be attached to the extension 140 with a quick-release mechanism or quick-release curtain attachment 149 having a body 150 and a curtain attachment assembly or curtain attachment or curtain holder 160. The quick-release mechanism has a locking mechanism 80. The curtain holder 160 during shipping and the initial assembly may be held together with a zip-tie, twist tie 90 or a retainer such as 500 shown in FIG. 4. Optionally, a second curtain or mesh 181 may be used with the extension and attached to the hood attachment or by other means.

Referring to FIG. 2, a track 110 is shown. The track is bolted, screwed, glued or otherwise attached to the ceiling. The track may also be on a hanging system and hang from the ceiling. The track 110 has an end piece (not shown) with snap connectors for the end piece. Running inside the track are roller hooks 120 having rollers. Additionally, other types of arrangements other than rollers 120 may be used so long as the slide easily along the track guides 118. Extending from the rollers are an eyelet 123 to which the eyelet of the hook 124 is attached. Other arrangements may be envisioned such as chains and other extenders for the roller hook. Over each hook, a covering 130 is affixed for quickly attaching the attachment 130 to the hook 125. FIG. 2 shows a housing or body 150, locking mechanism 80 and curtain holder 160 all for attaching the disposable curtains 180.

Referring to FIG. 3 is the quick-release curtain mechanism 149 having a body or housing 150 and a locking mechanism 80. The curtain attachment or curtain holders 160 has an alignment member 161 for alignment with other curtain holders 160. An advantage of the curtain holders 160 is that they can align and be held together using the alignment members 161 which insert in a receiving member (not shown see 167 in FIG. 11). In this manner all the curtain holders 160 may be simultaneously inserted into the channels 151 as shown in FIGS. 7 and 8. The curtain holders, extension holder and hook attachment are all made with injection molded parts using biodegradable materials as hereinafter described. It should be noted that although the curtain and its hardware are made using different manufacturing processes (i.e., a non-woven web extrusion of the curtain versus injection molding of the curtain hardware), they are both made from the same material.

FIGS. 5-8 show the quick release curtain mechanism or quick release curtain attachment 149 and locking mechanism 80 having a body 150 for holding the head 163 of the curtain attachment. Referring to FIG. 5, the quick release body or housing 150 has an upper side 300 and a lower side 302. The lower side has a slot 311 for receiving the neck (See 162 in FIGS. 11 and 12) of the curtain holder 160. Openings 321 are shown which allow flexibility of the arms 322 (see FIG. 5). A cavity 325 is shown which matches protrusion 320 so that the quick release and locking mechanisms may match when in an array as shown in FIGS. 1 and 2. The locking mechanism 80 (see FIGS. 9 and 10) slides in a first sliding slot 380. Nibs 381 and 382 engage the catch 381. The handle 810 of the locking mechanism 80 assists in sliding the lock up and down. On the side of the handle 810 is a female opening 820 for receiving a male protrusion 821.

FIG. 6 shows the opposite side of the quick release locking mechanism shown in FIG. 5. On this side can be seen the male protrusions 821 on the handle 810 of the locking mechanism 80. Also, can be seen the protrusions 320. Arms 322 may be seen inside cavities which lock the two pieces together. The quick release locking mechanism 80 may be made injection molding, machining or other manufacturing technics.

FIG. 7 shows a first side and an inside of a first side of the quick release curtain mechanism 149 and locking mechanism 80. Shown are the nibs 381 and 382 in the first sliding slot 380 for receiving the catch 831. The catch 831 slides along the first sliding slot 380. A second sliding slot 385 is also shown for receiving the forks 837, 836 of the locking mechanism 80. When the head 163 is in place at the base of the opening 310, the forks 837 and 836 may be slid into place. As the forks 837, 836 slide toward the neck receiving slot 311, the head 163 is locked into place. As the forks 837, 836 are moved away from the neck receiving slot 311 the head 163 may be removed. 151 shows the channel for receiving neck receiving opening 311, the head 163 can be removed. The channel opening or channel 151 is located on the side, front or back of the housing 150 so that when the head 163 is inserted it may be held in place by gravity. Cavity 319a is in place for receiving a magnet (not shown). The magnet assists in holding the array of quick release curtain mechanism 149 and locking mechanisms 80 in place as shown in FIGS. 1 and 2. 321 shows an opening for locking arms 322 to hold a first side of the quick release body or housing 150 to a second side of the quick release body or housing 150. Alignment posts 304 assist in aligning the first side and second side of the body or housing 150 together. 341 shows a channel for receiving a cable 133. Cavity 340 holds a swagged end of the cable in place.

FIG. 8 shows the second side of the body 150 of the quick release curtain mechanism 149 and locking mechanism 80. Shown are receiving openings 309 for receiving the alignment posts 304 for alignment of both sides of the body 150. The arms 322 for locking the two sides together are flexible so that the pieces may be snapped into place. This is so that the pieces may readily be assembled and disassembled for insertion and removal of the cable in channel 341 and swaged piece in 340. The arms 322 have a head with a catch 323. The arms 322 have a narrow section 324 for flexibility.

FIGS. 9 and 10 show the locking mechanism 80. The locking mechanism 80 has a forked base 835 with tines 836 and 837. The tines 836 and 837 having a curved end and are spaced apart. The base 835 and tines 836, 837 slide through the second sliding slot 385. The tines are spaced apart a distance 383 from each other. The spacing 838 is so that the neck 162 can have a greater degree of movement when installed. In the first sliding slot, the catch 831 may slide through. The catch 831 is slotted at 833 and has a top and bottom part 832 so that it may flex when engaging the nibs 382 and 381. Alternatively, the catch may be solid for a firmer grip. The base 835 has a holder 830 for the handle 810 of the locking mechanism 80. The handle 810 has a lower face 808 and an upper face 809 so that it may be gripped by fingers. The base 835 has a lower face 839.

The curtain 180 and second curtain or mesh 181 are a non-woven web which is manufactured mixing polymeric beads and additive beads as hereinafter described together and then binding and melting them by increasing temperature to form a sheet or web (similar to paper on a paper machine).

With reference to FIGS. 11 through 14, a curtain holders 160 is shown. The curtain holder has a first piece 170 and a second piece 165. The first piece 170 has a head 163 with a flat part 168 and a neck 162. The flat part 168 of the head 163 is for guiding the head into the channel 151 in order to allow adequate clearance. The first piece 170 and second piece may be attached together with arms 166 and locking head 159. The locking head 159 goes into opening 158 to snap into place. Other forms of attachment may also be used such as adhesive, melting of plastic, etc. The curtain holders 160 also include a guiding slot 167 and a protrusion 161 for alignment when the curtains an in an array. Projections 91 and 92 are to assist in aligning a twist wire (see FIG. 1) or an alignment tool or retainer 500 in FIG. 4.

In addition to the above embodiments, it is envisioned that other types of sliding locking mechanism 80 may be made. Sliding not only includes linear sliding, but also rotary sliding of parts.

The non-woven polypropylene curtains are typically made using a process called “spunbonding.” Spunbonding is a method of producing non-woven fabrics from polypropylene fibers. The process involves extruding molten polypropylene, which then solidifies into fine fibers. These fibers are collected and bonded together to form a cohesive sheet of non-woven fabric, which is then used to make curtains and other products. Here are the main steps involved in manufacturing non-woven polypropylene curtains:

Polymer Extrusion: The process starts with the extrusion of polypropylene polymer. Polypropylene resin is melted and then forced through fine spinnerets (nozzles with small holes) to create continuous filaments or fibers.

Filament Laying: The extruded filaments are laid down onto a moving conveyor belt in a random or semi-random arrangement. This web of filaments forms the primary layer of the non-woven fabric.

Web Formation: As the filaments are laid down, the random arrangement creates a loose web of fibers. The thickness and weight of the web can be controlled based on the speed of the conveyor belt and the amount of extruded polymer.

Bonding: The loose web of filaments needs to be bonded together to create a cohesive non-woven fabric. This can be achieved through one of several methods:
a. Heat Bonding: The web of filaments passes through a heated oven or calender rolls, where the heat softens the polypropylene fibers and causes them to bond together as they cool down.
b. Chemical Bonding: Chemical binders or adhesives can be applied to the web to bond the fibers together.
c. Mechanical Bonding: The web can be mechanically needled or entangled to interlock the fibers and form a strong fabric.

Finishing: After bonding, the non-woven fabric may undergo additional finishing processes to improve its properties, such as adding water or oil repellency, antimicrobial, flame resistance, or dyeing to achieve the desired color.

Conversion: Once the non-woven fabric is ready, it is cut and sewn into the shape of curtains. Grommets, hems, and other finishing touches may be added as required.

Non-woven polypropylene curtains have gained popularity due to their affordability, lightweight, and resistance to moisture. They are commonly used in various settings, including homes, hospitals, hotels, and other commercial spaces.

Nonwoven fabrics are engineered fabrics that may be single-use, have a limited life, or be very durable. Nonwoven fabrics provide specific functions such as absorbency, liquid repellence, resilience, stretch, softness, strength, flame retardancy, washability, cushioning, thermal insulation, acoustic insulation, filtration, use as a bacterial barrier and sterility. These properties are often combined to create fabrics suited for specific jobs, while achieving a good balance between product use-life and cost. They can mimic the appearance, texture and strength of a woven fabric. The advantage is that they are non-porous and thus can replace cloth curtains as an alternate to provide an easily cleanable surface that will not be harmed by cleaning materials such as hydrogen peroxide or bleach.

The curtain hardware (quick-release mechanism 149, a curtain attachment assembly or curtain holders 160, locking mechanism 80 and a retainer such as 500, grommets and curtain snaps 105) may be made using polypropylene beads and additive beads, for example, through the injection molding process using a technique called “foamed injection molding” or “muCell® injection molding.” In this process, the polypropylene and additive beads are expanded with a gas to create a foamed or cellular structure within the material. The foamed polypropylene then undergoes injection molding to produce the desired parts. The following are typical steps:

Polypropylene bead and additive bead preparation: Polypropylene beads and additive beads, also known as resin pellets or microspheres, are first loaded into the hopper of an injection molding machine.

Gas injection: During the injection molding process, a physical blowing agent or gas (such as nitrogen or carbon dioxide) is introduced into the polymer melt. The gas is typically injected into the molten polypropylene at high pressure, causing the beads to expand and creating a cellular structure within the material.

Mold filling: The foamed polypropylene and additive is injected into the mold cavity under pressure. The mold is designed to match the desired shape of the part being produced.

Cooling and solidification: Once the mold cavity is filled, the foamed polypropylene and additive cools and solidifies within the mold, taking the shape of the mold cavity.

Part ejection: After the material has solidified sufficiently, the mold opens, and the foamed polypropylene part is ejected from the mold.

Advantages of foamed injection molding using polypropylene beads and additive bead:

Lightweight: The cellular structure created by foaming the polypropylene results in a lighter weight part compared to solid injection-molded parts, making it suitable for applications where weight reduction is essential.

Reduced material usage: The foaming process allows for a reduction in the amount of polypropylene and additive material required to produce the same-sized part, leading to potential cost savings.

Improved mechanical properties: Foamed polypropylene parts can exhibit enhanced mechanical properties, such as increased impact resistance and energy absorption.

Enhanced insulation: The cellular structure provides improved thermal and acoustic insulation properties, making foamed polypropylene suitable for applications requiring insulation.

It's worth noting that while foamed injection molding offers various benefits, the process is more complex and requires specific equipment and expertise compared to traditional injection molding using solid polypropylene resins. As with any manufacturing process, careful optimization and control are essential to achieve desired properties and consistency in the final parts.

In addition to “foamed injection molding”, polypropylene beads and additive beads can be injection molded using different techniques, depending on the specific requirements of the final product and the desired properties. Here are some of the different ways polypropylene beads may be injection molded:

Conventional Injection Molding: In conventional injection molding, the polypropylene beads are heated until they melt and then injected into a mold cavity under high pressure. The mold is typically made of two halves, and the molten polypropylene fills the cavity to take the shape of the final product. Once the material cools and solidifies, the mold opens, and the part is ejected.

Gas-Assisted Injection Molding (GAIM): In gas-assisted injection molding, the polypropylene beads are injected into the mold cavity while a controlled amount of gas is simultaneously introduced. The gas displaces the molten plastic, pushing it against the mold walls and hollowing out the center of the part. This process is often used to create parts with thick walls, reducing material usage and cycle times.

Structural Foam Injection Molding: In structural foam injection molding, a blowing agent is mixed with the melted polypropylene beads before injection. The blowing agent creates a cellular structure within the material, similar to foamed injection molding. Structural foam molding produces parts with a smooth surface finish and enhanced strength-to-weight ratio.

Gas Counter Pressure Injection Molding (GCPIM): In GCPIM, the mold cavity is partially filled with polypropylene beads, and then a gas (often nitrogen) is injected to apply counter pressure against the material, preventing it from expanding beyond the desired shape. This process can help improve the surface finish and reduce sink marks in thick-walled parts.

Thermoset Injection Molding: While polypropylene is a thermoplastic material, some formulations of polypropylene can be modified to behave like a thermoset during injection molding. This involves adding special additives to the polymer that cause it to crosslink and harden permanently upon heating, similar to thermoset materials like epoxy.

Each of these injection molding techniques has its advantages and is chosen based on the specific requirements of the part, production volume, cost considerations, and the desired properties of the final product. Manufacturers often optimize the molding process and material formulation to achieve the best results for a particular application.

Although the disclosed:
a. curtain 180 and second curtain or mesh 181; and
b. the curtain hardware (quick-release mechanism 149, a curtain holder 160, locking mechanism 80, a retainer 500, grommets and snaps 105) are each made from the same material, polypropylene beads and additive beads, they are made using different manufacturing processes resulting in different durometer hardness.

Durometer hardness is a measure of the material's resistance to indentation. It is commonly used to assess the hardness of polymers and elastomers. The durometer hardness is measured using an instrument called a durometer, and the result is expressed as a number on a scale.

As described above, injection-molded polypropylene and additive is made using a manufacturing process used to produce solid parts by injecting molten plastic into a mold. The cooling and solidification of the plastic in the mold result in a relatively dense and rigid material. Injection-molded polypropylene products tend to have a higher durometer hardness because of the tightly packed polymer chains during the molding process.

Non-woven polypropylene: Non-woven polypropylene, on the other hand, is a fabric-like material made by bonding fibers together through mechanical, thermal, or chemical processes. Non-woven polypropylene products, such as the curtains are softer and more flexible compared to injection-molded polypropylene due to their fibrous nature and the way the fibers are entangled.

The durometer hardness of non-woven polypropylene will generally be lower than that of injection-molded polypropylene. However, it's important to note that the actual hardness can vary depending on the specific manufacturing processes and additives used in the production of each material. Different grades and formulations of polypropylene can result in variations in hardness, even within the same category of material. In the embodiments of the invention, it is important that the curtain hardware quick-release mechanism 149, a curtain attachment assembly or curtain holder 160, locking mechanism 80 and a retainer such as 500, grommets and snap(s) 105) are much more rigid than the curtains and curtain 180 and second curtain or mesh 181 so that the curtain hardware may firmly hold the curtain in place. For example, the locking mechanism 80 required many prototypes and revisions to arrive at a material thickness, rigidity and hardness to click and hold when in a raised position to hold into place. The more important or desirable curtain hardware that will be used for the disposable is the curtain holder 160, retainer 500 and snaps 105. These are the hardware components that will most frequently be thrown in a landfill when the curtains are replaced. Curtain hardware will range between Shore D 45 to Shore D60 with a desired range of Shore D 50 to Shore D55 wherein in this range it will strike a balance between flexibility and stiffness. While offering a good durability and still maintaining some flexibility, making them suitable for various curtain hardware applications.

In contrast, curtains are softer and more pliable and would be on the Shore A scale which is used to measure the hardness of soft pliable material. Shore A 30 to Shore A 70: Parts with durometer values in this range are considered relatively soft and flexible. They offer good flexibility, drape, and conformability, making them suitable for applications where softness and comfort are essential.

Shore A 40 to Shore A 60: Parts with durometer values in this range are moderately soft and still maintain some resilience. They are commonly used in nonwoven polypropylene products like disposable garments, wipes, and some types of bags.

Shore A 50 and below: Parts with durometer values in this range are very soft and pliable. Nonwoven polypropylene parts with such low hardness values are often used in applications where the material needs to be gentle against the skin, such as in medical products like surgical drapes or masks. The curtains of the embodiments of the present invention would have a Shore A 50 to Shore 70 hardness.

One embodiment of the invention would include adding an antimicrobial to the manufacturing process. The most common additives used to manufacture antimicrobial plastics include various isothiazolinone treatments, zinc pyrithione, thiabendazole, and silver antimicrobial products. Each active ingredient has its strengths and weaknesses.

The biodegradable composition may be used for a hospital disposable such as curtains (e.g. privacy or shower curtains), curtain hardware, surgical gowns, facemasks, disposable syringes, membranes for membrane oxygenators, connectors, finger-joint prostheses, non-absorbable sutures, pouches, test tubes, beakers, pipettes, reusable plastic containers, pharmacy prescription bottles and clear bags is disclosed. These are examples of hospital disposables that are creating a concern for disposal in landfills.

Although polypropylene is the desired material in combination with a biodegradable additive, an aspect disclosed in embodiments of the invention are hospital disposables made of one or more non-biodegradable polymer (e.g. polyethylene (PE), polypropylene (PP), polyester and/or polyvinylchloride (PVC)) and an additive comprising a blend or copolymer of (1) a first polymer selected from a poly-lactic acid (PLA) and/or a polyhydroxyalkanoates (PHA) and (2) a second polymer which is a poly-terephthalate. In one embodiment, the first polymer and second polymer are covalently bound to one another to form a copolymer. In another embodiment, the first polymer and second polymer are blended together to form an admixture but are not covalently bound to one another.

In one embodiment, the non-biodegradable polymer is present in the hospital disposable at a concentration of 90-99.9 wt. %, at a concentration of 95-99.5 wt. %, at a concentration of 98-99.5 wt. % or at a concentration of 99 wt. %, with the mass balance being the additive. In such embodiments, the additive is present at a concentration of 0.1-10 wt. %, 0.5-5 wt. %, 0.5-2 wt. % and 1% wt. %, respectively.

The first polymer is a PLA, a PHA or a combination thereof. The term PLA includes poly-D-lactic acid (PDLA), poly-L-lactic acid (PLLA) and combinations thereof. Specific examples of PHAs include poly-3-hydroxybutyrate (PHB), poly-3-hydroxybutyrate-co-4-hydroxybutyrate (P(3-HB-co-4-HB)), poly-3-hydroxybutyrate-co-valerate (PHBV), and polyhydroxybutyrate-co-hexanoate (PHBH). In one embodiment, the first polymer is PLA sold under the brand name INGEO® and has a number-average molecular weight of 127 kg per mole and a polydispersity index of 1.6. In other embodiments, the number-average molecular weight is between 100-150 kg per mole.

| PLA | PHA |
|---|---|
| 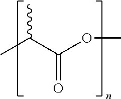 | 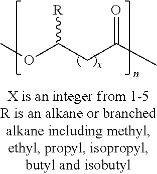 |

The second polymer is a poly-terephthalate. Examples include copolymers such as polybutylene adipate terephthalate (PBAT), polybutylene terephthalate, polycyclohexylenedimethylene terephthalate, polyethylene terephthalate, polytrimethylene terephthalate, poly(butylene succinate terephthalate) (PBST) and poly(butylene sebacate terephthalate). In one embodiment, the second polymer is a PBAT polymer sold under the brand name ECOFLEX® and has a number-average molecular weight of about 52 kg per mole and a polydispersity index of 2. In other embodiments, the number-average molecular weight is between 40 and 60 kg per mole.

In one embodiment, the additive comprises a blend of 30-70 wt. % of the first polymer and 30-70 wt. % of the second polymer. In another embodiment, the additive comprises a blend of 40-60 wt. % of the first polymer and 40-60 wt. % of the second polymer. In another embodiment, the additive comprises a blend of 45-55 wt. % of the first polymer and 45-55 wt. % of the second polymer. In another embodiment, the additive comprises a blend of 49-51 wt. % of the first polymer and 49-51 wt. % of the second polymer. In yet another embodiment, the additive consists of a blend of 49-51 wt. % of the first polymer and 49-51 wt. % of the second polymer.

In one embodiment, the second polymer is a blend/admixture of a polyester (1) and a poly-terephthalate (2), the structure of which are shown below. In another embodiment, the second polymer is a copolymer prepared by transesterifying polyester (1) and poly-terephthalate (2). The values of a, b and c are integers independently selected from 1-8. In one embodiment, a and c are integers from 1-6 and b is an integer from 1-8. In one embodiment, a and c are both 4. In one embodiment, b is an integer from 1-4. In another embodiment, b is an integer from 5-8. In one embodiment, the values of a, b and c are all four. The transesterification is performed using conventional methods including acid catalyzed transesterification. Organometallic catalysts are known for facilitating such a reaction including tetrabutoxytitanium and other zinc, tin and germanium-based catalysts. The transesterification may be performed at high temperature (e.g. greater than 190° C.) and under vacuum to facilitate removal of volatile byproducts, including water. During transesterification, random block copolymerization of the monomeric units may occur.

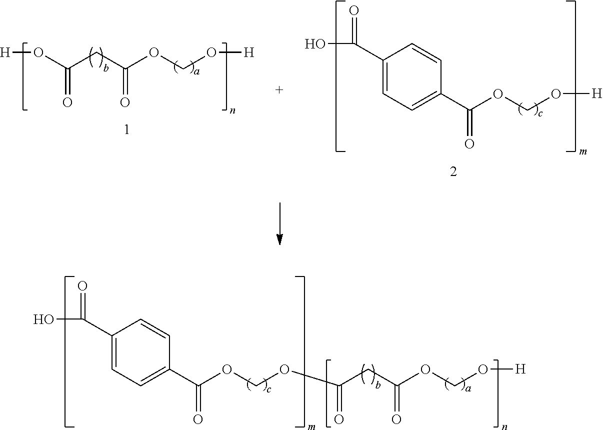

In one embodiment, a=b=c=4 and the poly-terephthalate (2) is polybutylene adipate terephthalate (PBAT).

In one embodiment, the values of m and n are within 30% of one another (e.g. a m:n molar ratio of 1.3:1 to a ratio of 1:1.3. In another embodiment, the values of m and n are within 20% of one another (e.g. a m:n ratio of 1.2:1 to 1:1.2). In another embodiment, the values of m and n are within 10% of one another (e.g. a m:n ratio of 1.1:1 to 1:1.1). In another embodiment, the values of m and n are within 5% of one another (e.g. a m:n ratio of 1.05:1 to 1:1.05). In another embodiment, the values of m and n are within 1% of one another (e.g. a m:n ratio of 1.01:1 to 1:1.01). In one embodiment, the terephthalate monomer is present in the additive at a concentration of less than 55 mol %.

The polyester (1) may be prepared from an alkane diol (3) and a diacid (R₁═H) (4). In one embodiment, R₁ in the diacid (4) is methyl, ethyl or propyl such that a corresponding diester is used. In one embodiment, a is four such that compound (3) is 1,4-butane diol. In some embodiments, R₁ is hydrogen and b is four (adipic acid), two (succinic acid) or eight (sebacic acid).

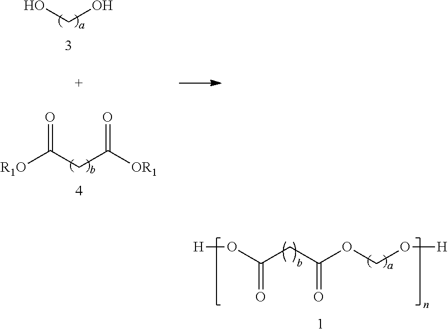

In one embodiment, R₁ is hydrogen and b is four (i.e. adipic acid) and a is four (i.e. 1,4-butane diol) as shown below.

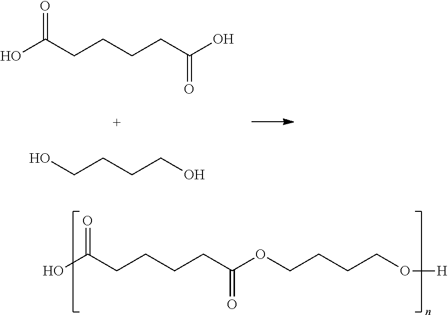

The poly-terephthalate (2) is prepared from a terephthalate ester (5) (or its corresponding acid) and alkane diol (6). In terephthalate ester (5) R₁ may be H or an alkane such as methyl, ethyl, propyl, isopropyl, etc. The value of c is an integer from 1-6. In one embodiment, c is four such that compound (6) is 1,4-butane diol.

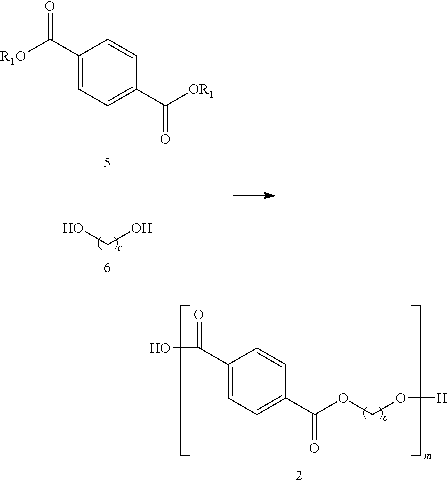

In one embodiment, R₁ is methyl and c is four, as shown below.

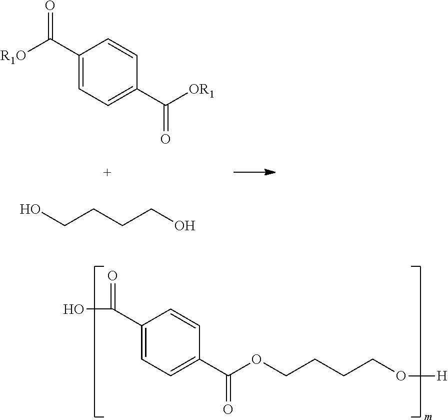

The additive has a crosslinking density that renders it biodegradable. In one embodiment, the crosslinking density is less than 30%, less than 20% or less than 10%. The crosslinking density can be determined by using ASTM-D2765. This method determines gel content and swell ratio for a known mass of polymer extracted with a suitable solvent. The extracted material is separated from the solvent and weighed after drying. The higher the mass of extracted material, the lower the crosslinking density.

The additive has a glass transition temperature (T_{g}) within or below the optimal temperature of mesophilic bacteria (e.g. a T_{g} within a temperature range of 20° C. to 45° C.).

In particular embodiments, the hospital disposable such as curtains 180 and curtain hardware comprises a polypropylene (as the non-biodegradable polymer) and an additive comprising a blend of poly-L-lactic acid (PLLA) and a poly-terephthalate. Another aspect is a hospital disposable made of 90-99.9 wt. % polypropylene and 0.1-10 wt. % of a blend of poly-L-lactic acid and a poly-terephthalate, or 95-99.5 wt. % polypropylene and 0.1-5 wt. % of a blend of poly-L-lactic acid and a poly-terephthalate, or 98-99.5 wt. % polypropylene and 0.1-2 wt. % of a blend of poly-L-lactic acid and a poly-terephthalate, or 99 wt. % polypropylene and 1 wt. % of a blend of poly-L-lactic acid and a poly-terephthalate.

A further aspect of the embodiments is an additive for use with polypropylene comprising a blend of 30-70 wt. % poly-L-lactic acid and 30-70 wt. % poly-terephthalate, or an additive for use with polypropylene comprising a blend of 40-60 wt. % poly-L-lactic acid and 40-60 wt. % poly-terephthalate, or an additive for use with polypropylene comprising a blend of 45-55 wt. % poly-L-lactic acid and 45-55 wt. % poly-terephthalate, or an additive for use with polypropylene comprising a blend of 49-51 wt. % poly-L-lactic acid and 49-51 wt. % poly-terephthalate.

Another aspect is a method of making a hospital disposable comprising the steps of: blending polypropylene with an additive of poly-L-lactic acid and a poly-terephthalate; and at least one of extruding, molding and forming a hospital disposable from the blend.

### Example 1

99 wt. % polypropylene solid beads were homogenously mixed/blended with 1 wt. % additive of solid beads comprised of 51 wt. % poly-L-lactic acid (PLLA) polymer and 49 wt. % poly(butylene adipate-co-terephthalate) (PBAT), or a copolymer of the two for 5 minutes. The mixture/blend was then injection molded into curtain hardware and curtain hangers.

### Example 2

99 wt. % polypropylene solid beads were homogenously mixed/blended with 1 wt. % additive of solid beads comprised of 51 wt. % poly-L-lactic acid (PLLA) polymer and 49 wt. % poly(butylene adipate-co-terephthalate) (PBAT), or a copolymer of the two for 5 minutes. The mixture/blend was then extruded into a flame-retardant, nonwoven 115 grams per square meter (gsm) polypropylene curtain.

The hardware produced by Example 1 was then assembled onto the curtain of Example 2 to provide a biodegradable curtain and hardware.

Another aspect of the invention is to provide a wrap or a sterilization wrap with accelerated biodegradation. Sterilization wrap, also known as surgical wrap or sterilization packaging, is typically made from a non-woven fabric that is specially designed to allow sterilization of medical instruments and equipment while maintaining sterility until they are ready for use in healthcare settings. FIG. 15 shows a surgical wrap or surgical drape 1001. The drape includes clear plastic panels 1002 and reinforcement 1004. In the center of the drape is fenestration 1006 for conducting the surgery. For example, surgical wrap is made from spun polypropylene and is incredibly resistant to tearing, and completely compatible with gas-plasma sterilization. Other types of surgical wrap includes surgical drapes table drape covers, Mayo® stand covers, hand drape, angiography drape, central line drape, jugular drape, cystoscopy drape, urological drape, neurosurgery drape, obstetrics drape, ophthalmology drape, EENT drape, orthopedic drape, pacemaker drape, pediatric drape, pre-gyn drape, cesarean drape, cardiac drape, under buttocks drape, T-drape, drape leggings, arm board drape covers and the like.

It is used under a tray to protect outer wrap from sharp corners and imperfections of sterilization trays. The unique color such as purple may be provided as a protective layer to distinguish from other sterilization wrap. It is available in 3 sizes to fit the most common sizes of trays. Here's a general overview of how sterilization wrap used in hospitals is made:

The primary material used in sterilization wrap is typically a non-woven fabric made from synthetic fibers such as polypropylene or polyester. These materials are chosen for their strength, durability, and ability to withstand the sterilization process without tearing or allowing microorganisms to penetrate.

The chosen synthetic fibers are processed and formed into a non-woven fabric through methods such as spunbonding or meltblowing. Spunbonding involves extruding fibers onto a moving belt to form a web, which is then bonded together using heat and pressure. Meltblowing involves extruding molten polymer through fine nozzles onto a moving belt, creating microfibers that are then cooled and bonded together to form a fabric.

Specialized Coating or Treatment: The fabric may undergo additional treatments or coatings to enhance its properties. For example, some sterilization wraps are treated with a hydrophobic coating to repel liquids and maintain a dry sterile barrier. Others may be treated with anti-static agents to reduce static build-up during handling or flame retardants.

Sterilization wraps often feature printed indicators such as sterilization process indicators (e.g., chemical indicators or color-changing indicators) to confirm that the sterilization process has been completed successfully. Labels with information such as lot numbers, expiration dates, and instructions for use may also be added.

The fabric is cut into appropriate sizes and shapes to accommodate different sizes of medical instruments and equipment. It may be folded or creased to facilitate wrapping and sealing.

Once the sterilization wraps are prepared, they are typically packaged in sterile pouches or rolls, often with an outer barrier such as plastic film to protect against contamination during storage and transportation.

Throughout the manufacturing process, rigorous quality control measures are implemented to ensure that the sterilization wraps meet regulatory standards and performance requirements for sterility, strength, and barrier properties.

Overall, the manufacturing process for sterilization wrap involves a combination of specialized materials, fabrication techniques, and quality control procedures to produce a product that effectively maintains sterility and protects medical instruments and equipment in healthcare settings.

### Example 3

99 wt. % solid beads selected from polypropylene (PP), polyamide, polyester, polyethylene (PE), polyvinylchloride (PVC) were homogenously mixed/blended with 1 wt. % additive of solid beads comprised of 51 wt. % poly-L-lactic acid (PLLA) polymer and 49 wt. % poly(butylene adipate-co-terephthalate) (PBAT), or a copolymer of the two for 5 minutes. The beads are then heated and formed into a spun polypropylene or polyester hospital disposable such as surgical drapes table drape covers, Mayo® stand covers, hand drape, angiography drape, central line drape, jugular drape, cystoscopy drape, urological drape, neurosurgery drape, obstetrics drape, ophthalmology drape, EENT drape, orthopedic drape, pacemaker drape, pediatric drape, pre-gyn drape, cesarean drape, cardiac drape, under buttocks drape, T-drape, drape leggings, arm board drape covers and the like.

Scope sleeves used in hospitals and medical facilities are typically made using specialized manufacturing processes and materials to ensure their effectiveness in maintaining sterility and preventing contamination. The exact methods and materials can vary depending on the manufacturer and the specific type of scope sleeve, but here is an overview of the general steps involved in making scope sleeves:

Scope sleeves are commonly made from materials such as polypropylene, polyethylene or polyurethane. FIG. 16 shows a scope sleeve 1050 on a scope such as an endoscope 1052. These materials are chosen for their durability, flexibility, and ability to create a barrier against contaminants while allowing visibility during procedures.

The manufacturing process often begins with extrusion or molding of the chosen material into the desired shape and dimensions of the scope sleeve. Extrusion involves forcing the material through a die to create a continuous profile, while molding uses molds to shape the material into specific forms.

After the material is formed, it is cut to the appropriate length for the scope sleeve. The ends of the sleeve are then sealed using heat sealing, sewing, or ultrasonic welding techniques to ensure a secure closure and prevent leakage or contamination.

Once the scope sleeves are manufactured and sealed, they undergo sterilization to eliminate any potential microorganisms and ensure they are safe for use in medical procedures. Common sterilization methods include ethylene oxide gas, gamma radiation, or steam autoclaving, depending on the material and manufacturer's specifications.

After sterilization, the scope sleeves are packaged in sterile packaging to maintain their cleanliness until they are ready to be used in healthcare settings. The packaging also often includes instructions for proper use and disposal.

It's important to note that manufacturers of scope sleeves adhere to strict quality control standards and regulatory requirements to ensure the safety and effectiveness of their products in healthcare settings. Additionally, advancements in materials science and manufacturing technology continue to improve the quality and performance of scope sleeves in maintaining aseptic conditions during medical procedures.

Personal protective equipment (hereinafter PPE) includes but is not limited to surgical bunny suits; gowns including, isolation gowns, surgeon gowns—blue, yellow, green, and cancer gowns (which requires a specific type of fluid barrier rating that make them significantly more expensive); surgeon hoods; rep caps; gloves, bouffant caps; foot covers; hair covers; and beard covers; and masks including regular mask, endoscopy mask (Pom mask) surgical mask, anti-fog masks, wrap around ear masks, double loop ear masks with anti-fog. FIG. 17 shows Personal Protection Equipment including, but not limited to a surgical gown 1100, foot covers 1105, gloves 115, N95 face mask, 1107, cap 1108 and face shield or surgical mask 1110.

PPE, are specialized garments worn by healthcare professionals, technicians, or individuals working in controlled environments like cleanrooms or sterile areas within hospitals. PPE is designed to minimize the introduction of contaminants and maintain a clean environment. Here is an overview of how PPE is typically made:

PPE is made from materials that provide protection against particulates, liquids, and biological contaminants while allowing the wearer to move comfortably. Common materials include non-woven fabrics like polypropylene, polyester, or polyethylene, which are lightweight, breathable, and durable.

Manufacturers create patterns for PPE based on the desired style, functionality, and size requirements. The pattern may include pieces for the body, sleeves, hood, and closures such as zippers, snaps, or hook-and-loop fasteners.

Once the pattern is established, the chosen fabric is laid out in layers, and the pattern pieces are cut according to size and shape. Precision cutting ensures consistency and accuracy in the construction of the PPE.

The cut fabric pieces are then sewn together by skilled seamstresses or using automated sewing machines. Seams are often reinforced and sealed to enhance durability and prevent particle penetration.

Depending on the specific design and intended use, additional features may be added during the manufacturing process. This may include attaching elastic cuffs at the wrists and ankles for a secure fit, incorporating a hood with an elasticized opening or adjustable closures, and adding pockets or flaps for convenient storage of small items.

Throughout the production process, quality control measures are implemented to ensure that each PPE meets the required standards for cleanliness, fit, and functionality. Inspections may include checking for defects, proper seam sealing, accurate sizing, and adherence to specifications.

Once the PPE is manufactured and inspected, they may undergo sterilization using methods such as gamma radiation, ethylene oxide gas, or steam autoclaving, depending on the material and manufacturer's protocols. After sterilization, the suits are individually packaged in sterile packaging to maintain their cleanliness until they are ready to be used.

It's important to note that PPE is typically designed to be disposable, meaning they are intended for single-use to minimize the risk of cross-contamination. Manufacturers of PPE follow strict guidelines and standards to ensure their effectiveness in maintaining hygiene and preventing the spread of contaminants in healthcare settings.

The production of personal protective equipment (PPE) masks typically involves several steps:

Material Selection: PPE masks can be made from various materials, including non-woven fabrics like polypropylene, which is commonly used for its filtration properties. Other materials like polyester blends might also be used, especially for reusable masks.

Cutting: Once the materials are selected, they are cut into appropriate shapes and sizes. This can be done manually or using automated cutting machines, depending on the scale of production.

Assembly: The cut pieces are then assembled to form the mask. This involves sewing or heat sealing the layers together, depending on the design of the mask. Elastic bands or adjustable straps are also attached during this stage to ensure the mask fits securely over the face.

Filtration Layer: For masks designed to filter out particles, a filtration layer is incorporated into the mask. This layer is typically made from melt-blown polypropylene, which traps tiny particles while allowing air to pass through.

Nose Wire: Some masks include a nose wire or nose bridge strip, which helps the mask conform to the shape of the wearer's face and reduces gaps where air can leak.

Finishing Touches: Once the mask is assembled, any necessary finishing touches are made. This might include trimming excess material, reinforcing seams, or adding any additional features, such as adjustable nose clips or filter pockets.

Quality Control: Throughout the manufacturing process, quality control measures are implemented to ensure that the masks meet safety standards and specifications. This can involve visual inspections, testing for filtration efficiency, and other quality checks.

Packaging: Once the masks pass quality control, they are packaged for distribution. Packaging may vary depending on the intended use of the masks and the preferences of the manufacturer and end-user.

These steps may vary slightly depending on the specific design and manufacturing processes used by different companies or facilities. Additionally, advancements in technology and materials may lead to changes in the manufacturing process over time.

It's important to note that making medical devices like endotracheal tubes (ETTs) and laryngeal mask airways (LMAs) and associated collars and holders should be done by qualified professionals or under strict medical device manufacturing standards. These devices are crucial for airway management in medical procedures and require precision engineering, sterile manufacturing conditions, and regulatory compliance to ensure safety and efficacy.

The manufacturing processes involved in making endotracheal tubes includes:

Medical-grade PVC or silicone tubing for the main body of the ETT. Cuffs made of PVC or silicone for sealing the airway. FIG. 16 shows a cover 1050 for an endoscope tube 1052. Connector for attaching to ventilation equipment. Radiopaque line or marker for visualization during X-rays.

To manufacture the product the following is needed:
a. Tube Extrusion: The main body of the ETT is typically made through extrusion of medical-grade PVC or silicone. This process involves forcing the material through a die to create a continuous tube of the desired diameter and length.
b. Cuff Formation: Cuffs are usually made separately and attached to the tube. They may be molded from PVC or silicone and inflated with air or a cuff inflation system to seal the airway securely.
c. Connector Assembly: A connector is attached to one end of the ETT to facilitate connection to ventilation equipment such as a ventilator or bag-valve-mask device.
d. Radiopaque Marker: A radiopaque line or marker is embedded in the tube or added externally to ensure visibility on X-rays, allowing healthcare providers to confirm the tube's position.

The manufacture of Laryngeal Mask Airways (LMAs) includes: Medical-grade silicone for the mask portion that sits in the pharynx. Inflatable cuff made of silicone for sealing around the laryngeal inlet. Tube for connecting to ventilation equipment. Pilot balloon and valve for cuff inflation and deflation.

The manufacture includes:
a. Mask and Cuff Formation: The mask and inflatable cuff are typically molded from medical-grade silicone. The cuff is attached to the mask and designed to seal around the laryngeal inlet when inflated.
b. Tube Attachment: A tube is integrated into the mask assembly for connecting to ventilation equipment. This tube allows for the passage of air into the patient's airway.
c. Pilot Balloon and Valve: A pilot balloon and inflation valve are included to allow healthcare providers to inflate and deflate the cuff as needed for proper placement and sealing.

Both ETTs and LMAs are regulated medical devices, and their manufacturing must adhere to strict quality standards and regulatory requirements, such as those outlined by the Food and Drug Administration (FDA) in the United States or similar regulatory bodies in other countries. Manufacturers must conduct rigorous testing, quality control measures, and adhere to Good Manufacturing Practices (GMP) to ensure the safety, effectiveness, and sterility of these devices. In summary, while understanding the components and general manufacturing processes of endotracheal tubes and laryngeal mask airways is informative, actual production should be left to qualified medical device manufacturers who comply with regulatory standards to ensure patient safety and product efficacy.

The injection molded plastic was tested under standard ASTM D5511. This test method covers the determination of the degree and rate of anaerobic biodegradation of plastic materials in high-solids anaerobic conditions. The test materials are exposed to a methanogenic inoculum derived from anaerobic digesters operating only on pretreated household waste. The anaerobic decomposition takes place under high-solids (more than 30% total solids) and static non-mixed conditions. This test method is designed to yield a percentage of conversion of carbon in the sample to carbon in the gaseous form under conditions found in high-solids anaerobic digesters, treating municipal solid waste.

Anaerobic digested sewage sludge was mixed with household waste. To make the sludge adapted and stabilized during a short post-fermentation at 53° C., the sludge was pre-incubated (one week) at 53° C. This means that the concentrated inoculum was not fed but allowed to post ferment the remains of previously added organics allowing large easily biodegradable particles were degraded during this period and reduce the background level of biogas from the inoculums itself.

A sample of the anaerobic digested sewage sludge was analyzed for pH, percent dry solids, and volatile solids, as well as, the amount of CO2 and CH4 evolution during the testing. Table 1 lists the results of this initial testing.

Inoculum Medium: Remove enough inoculum (approximately 15 kg) from the post-fermentation vessel and mix carefully and consistently by hand in order to obtain a homogeneous medium. Test three replicates each of a blank (inoculum only), Positive control (Reference material) (thin-layer chromatography cellulose), negative control (optional), and the test substance being evaluated.

Manually mix 1000 g wet weight (at least 20% dry solids) of inoculum in a small container for a period of 2 to 3 min with 15 to 100 g of volatile solids of the test substance or the controls for each replicate. For the three blanks containing inoculum only, manually mix 1000 g of the same inoculum in a small container for a period of 2 to 3 min with the same intensity as was done for the other vessels containing test substance or controls. Determine the weight of the inoculum and test substance added to each individual Erlenmeyer flask accurately. Add the mixtures to a 2-L wide-mouth Erlenmeyer flask and gently spread and compact the material evenly in the flask to a uniform density.

After placing the Erlenmeyer flask in incubator, connect it with the gas collection device. Incubate the Erlenmeyer flasks in the dark or in diffused light at 52° C. (±2° C.) for thermophilic conditions. The incubation time shall be run until no net gas production is noted for at least five days from both the Positive control (Reference material) and test substance reactors. Control the pH of the water used to measure biogas production to less than two by adding HCl.

The most important biochemical characteristics of the inoculum such as pH, Volatile Fatty Acids, NH4+−N— and dry solids were studied.

TABLE 1
Results of Initial testing of the
anaerobic digested sewage sludge

| | | | Actual |
|---|---|---|---|
| Parameters | Requirement | | results |
| pH | 7.5 to 8.5 | | 7.85 |
| Kjeldahl | 0.5 to 2 | g/kg wet weight | 1.46 |
| nitrogen | | | |
| Dry Solids | >20% | | 44.00 |
| at 105° C. | | | |
| Volatile Solids | Below 1 | g/kg wet weight | 0.76 |
| at 550° C. | | | |

The biogas volume in the gas sampling bag was measured (Table—2). Presence of gas in the gas collector of Positive control indicated that the inoculum was viable and gas displacement was observed both in Positive control and Test Sample.

ASTM D5511 states that for the test to be considered valid, the Positive control must achieve 70% within 30 days with deviation less than 20% of the mean between the replicates.

Positive control (Reference material) showed 71.03% on 27th day with less than 20% of the mean difference between the replicates.

The gas displacement observed after 90 days is as shown in the table below.

TABLE 2
Biogas volume of the evolved gas during
the biodegradation process at 90 days

| Biodegradation | Total Volume |
|---|---|
| Test | 90 days (mL) |
| Inoculum | 2840 |
| Positive control | 10100 |
| (Reference material) | |
| Bioplastic | 6500 |

The percent biodegradation of Positive control (and Test sample was calculated by the measured cumulative carbon dioxide and methane production from each flask after subtracting carbon dioxide evolution and methane evolution from the blank samples at the end 90 days of testing. Calculations were based on Total Organic Carbon obtained of both Positive control and Test sample.

TABLE 3a
Percentage biodegradability of Test sample
with respect to Positive control

| | | Positive | |
|---|---|---|---|
| | | control | Biodegradable |
| | Inoculum | (Reference | plastic |
| Cellulose. Group | control | material) | Sample |
| Weight | 1000 ml | 102305 g | 10.1335 g |
| Total volume (ml) | 2840.00 | 10100.00 | 6500.00 |
| % CH4 | 13.20 | 44.90 | 21.80 |
| Volume of CH4 | 374.88 | 4534.90 | 1417.00 |
| (ml) | | | |
| weight of CH4 (g) | 0.2459 | 2.9749 | 0.9296 |
| % CO2 | 15.70 | 45.50 | 24.20 |
| Volume of CO2 | 445.88 | 4595.50 | 1573.00 |
| (ml) | | | |
| Weight of CO2 (g) | 0.8828 | 9.0991 | 3.1145 |
| Total weight of | 0.4228 | 4.6879 | 1.5381 |
| carbon in grams | | | |
| Theoretical weight | — | 4.3040 | 8.4999 |
| of carbon in grams | | | |
| (Ci) | | | |
| Biodegradation | — | 0.99097 | 0.13121 |
| % Biodegradation | — | 99.10 | 13.12 |

Based upon the above, the biodegradable polymer/plastic showed a 13.12% biodegration over 90 days. This satisfies the ASTM D5511 standards for biodegradation.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed is:

1. A biodegradable disposable wherein:
the biodegradable disposable is selected from one of a drape, personal protection equipment, endotracheal tubes (ETTs) and laryngeal mask airways (LMAs),
wherein the biodegradable disposable is made of a non-biodegradable polymer selected from a group consisting of polypropylene (PP), polyamide, polyester, polyethylene (PE), polyvinylchloride (PVC), polyurethane and combinations thereof; and
an additive comprising a blend or copolymer of (1) a first polymer selected from a poly-lactic acid (PLA), a polyhydroxyalkanoates (PHA) or a combination thereof and (2) a second polymer which is a poly-terephthalate.

2. The biodegradable disposable of claim 1, wherein the drape is selected from one of a surgical drapes table drape covers, Mayo® stand covers, hand drape, angiography drape, central line drape, jugular drape, cystoscopy drape, urological drape, neurosurgery drape, obstetrics drape, ophthalmology drape, EENT drape, orthopedic drape, pacemaker drape, pediatric drape, pre-gyn drape, cesarean drape, cardiac drape, under buttocks drape, T-drape, drape leggings, and arm board drape covers.

3. The biodegradable disposable of claim 1, wherein the personal protection equipment is selected from a surgical bunny suit, a gown, a surgeon hood, a rep caps, a bouffant cap, a foot cover, a hair cover, a beard cover, and a mask.

4. The biodegradable disposable of claim 3, wherein the gown is one of an isolation gown, a surgeon gown, and a cancer gown.

5. The biodegradable disposable of claim 3, wherein the mask is an endoscopy mask or Pom mask, a surgical mask, an anti-fog mask, a wrap around ear mask, and a double loop ear masks with anti-fogging.

6. The biodegradable disposable of claim 1, wherein the non-biodegradable polymer further comprising:
an antimicrobial additive.

7. The biodegradable disposable of claim 6, wherein the antimicrobial is selected from isothiazolinone treatments, zinc pyrithione, thiabendazole, and silver.

8. The biodegradable disposable of claim 1, wherein the non-biodegradable polymer is present in a concentration from 95-99.5 wt. % and the additive is present in a concentration from 0.5-5 wt. %.

9. The biodegradable disposable of claim 8, wherein the non-biodegradable polymer is present in a concentration from 98-99.5 wt. % and the additive is present in a concentration from 0.5-2 wt. %.

10. The biodegradable disposable of claim 9, wherein the non-biodegradable polymer is present in a concentration of 99 wt. % and the additive is present in a concentration of 1 wt. %.

11. The biodegradable disposable of claim 1, wherein the poly-terephthalate is a random block copolymer of: 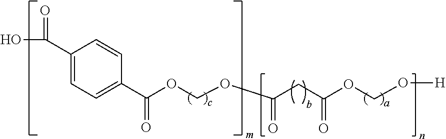
wherein a and c are independently selected integers from 1 to 6, b is an integer from 1 to 8, and m and n are numbers that are within 30% of one another.

12. The biodegradable disposable of claim 1, wherein the additive is a blend of (1) the first polymer which is poly-L-lactic acid (PLLA) and (2) the poly-terephthalate is a random block copolymer of 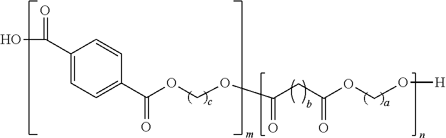
wherein a and c are independently selected integers from 1 to 6, b is an integer from 1 to 8, and m and n are numbers that are within 20% of one another.

13. The biodegradable disposable of claim 12, wherein m and n are within 10% of one another.

14. The composition of matter as recited in claim 13, wherein m and n are within 5% of one another.
